(19) United States
(12) Patent Application Publication
(10) Pub. No.: US 2017/0202389 A1
(43) Pub. Date: Jul. 20, 2017

(54) COOKING APPARATUS

(71) Applicant: IRIS OHYAMA INC., Aoba-ku (JP)

(72) Inventor: Tatsuya Shin, Kakuda (JP)

(21) Appl. No.: 14/995,943

(22) Filed: Jan. 14, 2016

(51) Int. Cl. A47J 27/04; A47J 36/06

(52) U.S. Cl. CPC A47J 27/04; A47J 36/06; A47J 2027/043

(57) ABSTRACT

A cooking apparatus with: a) a main vessel defining a treatment space and having a bottom wall and a peripheral wall extending upwardly from the bottom wall into a rim; and b) a lid that is repositionable relative to the main vessel to selectively control access to the treatment space. The lid has an edge portion that cooperates with the rim with the lid in a closed position. The rim has vertically spaced, upwardly facing, first and second surfaces. The edge portion has third and fourth surfaces that are configured to cooperate, one each, with the first and second surfaces with the lid in the closed position to each engage and/or reside in close proximity to its respective cooperating first and second surface with the lid in the closed position.

### BACKGROUND OF THE INVENTION

Field of the Invention

This invention relates to cooking apparatus of the type having a main vessel, defining a treatment space, and an associated repositionable lid.

Background Art

One known cooking apparatus configuration consists of a main vessel with an associated repositionable lid. Myriad different versions of this basic design are currently available in the marketplace. The repositionable lid is typically fully separable from the main vessel to allow access to a treatment space bounded by the main vessel. The main vessel has a peripheral wall with an upper rim that supports the lid in a closed position therefor. The lid has an edge portion with a complementary shape that bears against the vessel rim with the lid in the closed position.

Typically, the rim and edge portion are configured to cooperate in a manner so as to: a) consistently locate the lid on the main vessel with the lid in a closed position; and b) create a seal that limits vapor escape from the treatment space and allows a certain degree of pressure build-up within the treatment space as food products are being processed therewithin at elevated temperatures.

There is an increasing trend towards cooking foods primarily through the use of steam. One category of such cooking apparatus positively, sealingly secures the lid to its associated main vessel to allow relatively high pressure to be generated in the cooking space.

Short of effecting a positive seal, a highly effective method of steam cooking can be carried out using cooking apparatus with a lid that controls, but does not fully block, vapor escape from the treatment space. Such cooking apparatus rely primarily upon the weight of the lid to maintain a seal between the lid and the main vessel.

In one typical construction, the lid edge portion and main vessel rim extend continuously around the treatment space—in the event of a circular configuration, around a vertical central axis thereof. Radially facing surfaces on the main vessel and lid cooperate to center the lid consistently in its closed/operative position. Axially oppositely facing surfaces on the lid and main vessel abut or are in close proximity with the lid in its closed position. The cooperating surfaces on the lid and main vessel create at least a partial seal, thereby to confine vapor in the treatment space.

During a cooking operation, vapor may migrate to between the axially facing surfaces on the lid and main vessel to create a water layer that tends to float the lid upwardly. This permits escape of steam between the lid and main vessel, particularly where the floating layer is interrupted.

Many cooking techniques benefit from the ability to control the pressure in the treatment space by controlling the escape of steam/vapor therefrom. For this purpose, valves have been incorporated into lids constructed to selectively allow: a) blocking of steam through the lid valve; and b) controlled release of steam from the treatment space through the valve into the surrounding environment.

While the incorporation of valves into steam cooking apparatus has been a desirable feature, heretofore the control of steam escape has been relatively imprecise, primarily due to the fact that the escape of steam from between the lid edge portion and main vessel rim has been relatively unpredictably controlled. As noted above, the seal between the lid and main vessel is effected primarily by the confronting, axially facing surfaces on the lid edge portion and main vessel rim. Since steam generation progressively increases pressure within the treatment space as the cooking temperature is elevated, the lid has a tendency to be elevated relative to the main vessel and remain “floating” on a condensed liquid layer. This elevation force is resisted primarily by the weight of the lid. At different temperatures, and depending upon the contents of the cooking space, this elevating force may vary significantly. Thus, the nature of the floating layer, described above, and its continuity may be relatively uncontrolled. At certain pressures, the seal between the axially facing surfaces may be significantly compromised so that the loss of steam, that could be beneficial in cooking, becomes uncontrolled and excessive. Thus, the benefits of steam cooking may not be fully realized.

In spite of the limitations of the prior art, the industry has continued to contend with the above issues, for want of a viable solution. The industry continues to seek out improved cooking apparatus configurations that rely on steam/vapor treatment of food products in a treatment space.

### SUMMARY OF THE INVENTION

In one form, the invention is directed to a cooking apparatus with: a main vessel defining a treatment space and having a bottom wall and a peripheral wall extending upwardly from the bottom wall into a rim; and a lid that is repositionable relative to the main vessel to selectively control access to the treatment space. The lid has an edge portion that cooperates with the rim with the lid in a closed position. The rim has vertically spaced, upwardly facing, first and second surfaces. The edge portion has third and fourth surfaces that are configured to cooperate, one each, with the first and second surfaces with the lid in the closed position to each engage and/or reside in close proximity to its respective cooperating first and second surface with the lid in the closed position.

In one form, each of the rim and edge portion extends in a continuous configuration.

In one form, the first surface and one of the third and fourth surfaces, that cooperates with the first surface with the lid in the closed position, each has a flat shape.

In one form, the second surface and the other of the third and fourth surfaces, that cooperates with the second surface with the lid in the closed position, each has a flat shape.

In one form, the main vessel has a vertical axis. The main vessel and lid have a first pair of radially facing surfaces that engage and/or reside in close proximity with the lid in the closed position.

In one form, the main vessel and lid have a second pair of radially facing surfaces that engage and/or reside in close proximity with the lid in the closed position.

In one form, the first and second pairs of radially facing surfaces are spaced vertically from each other with the lid in the closed position.

In one form, at least one of the first and second pairs of radially facing surfaces has surfaces that are substantially flat and angled with respect to the central axis as viewed in cross-section in a plane including the central axis so as to interact and guide the lid downwardly relative to the main vessel consistently into the closed position.

In one form, one of the first and second pairs of radially facing surfaces resides vertically between the first and second rim surfaces with the lid in the closed position.

In one form, the surfaces in the first pair of radially facing surfaces each has a first vertical extent, with the lid in the closed position, that is approximately the same. The surfaces in the second pair of radially facing surfaces each has a second vertical extent, with the lid in the closed position, that is approximately the same. The first and second vertical extents are approximately the same.

In one form, the main vessel has a vertical axis. The first and second surfaces have radial extents that are approximately the same.

In one form, each of the first and second surfaces is made from a metal material.

In one form, the lid has an inverted, cup-shaped inside surface bounding the treatment space with the lid in the closed position. There are a plurality of discrete projections at the inside surface that facilitate accumulation of a fluid that is vaporized in the treatment space and condensed at the inside lid surface.

In one form, the lid has a vertical axis. An opening spaced radially inwardly from the edge portion allows escape of vapor from within the treatment space with the lid in the closed position.

In one form, the lid further includes a valve assembly that is reconfigurable to allow controlled escape of different volumes of vapor from within the treatment space through the lid opening with the lid in the closed position.

In one form, the lid has a weight. The lid is maintained in the closed position by only the weight of the lid.

In one form, the invention is directed to a cooking apparatus with: a main vessel defining a treatment space and having a bottom wall and a peripheral wall extending upwardly from the bottom wall and extending into a rim; and a lid that is repositionable relative to the main vessel to selectively control access to the treatment space. The lid has an edge portion that cooperates with the rim with the lid in a closed position. The main vessel has a vertical axis. The main vessel and lid have first and second pairs of radially facing surfaces. The surfaces in each of the first and second pairs of radially facing surfaces engage and/or reside in close proximity with the lid in the closed position. The first and second pairs of radially facing surfaces are spaced vertically from each other with the lid in the closed position. The main vessel and lid have cooperating axially oppositely facing surfaces, one each on the rim and edge portion, that engage and/or reside in close proximity with the lid in the closed position.

In one form, the axially oppositely facing surfaces reside between the first and second pairs of radially facing surfaces with the lid in the closed position.

In one form, at least one of the first and second pairs of radially facing surfaces are surfaces that are substantially flat and angled with respect to the central axis as viewed in cross-section in a plane including the central axis so as to interact and guide the lid downwardly relative to the main vessel into the closed position.

In one form, the lid has an opening spaced radially inwardly from the edge portion to allow escape of vapor from within the treatment space with the lid in the closed position.

### BRIEF DESCRIPTION OF THE DRAWINGS

FIG. 1 is a schematic representation of a cooking apparatus, according to the present invention, and including a main vessel and an associated repositionable lid;

FIG. 2 is a schematic representation of structure on the cooking apparatus in FIG. 1 cooperating between an edge portion on the lid and rim on the main vessel with the lid in a closed position;

FIG. 3 is an exploded perspective view of one exemplary form of the cooking apparatus in FIGS. 1 and 2;

FIG. 4 is a view as in FIG. 3 with the lid in its closed position;

FIG. 5 is an enlarged, fragmentary, cross-sectional view of the cooking apparatus taken along line 5-5 of FIG. 4;

FIG. 6 is an enlarged, bottom perspective view of the lid in FIGS. 3-5;

FIG. 7 is an enlarged, exploded, perspective view of the lid in FIGS. 3-6 and a valve assembly thereon;

FIG. 8 is an enlarged, fragmentary, side elevation view of a portion of the lid with the valve assembly in FIG. 7 operatively connected thereto;

FIG. 9 is an enlarged, bottom view of the valve assembly separated from the rest of the lid; and

FIG. 10 is an enlarged schematic view, corresponding to that in FIG. 5.

### DETAILED DESCRIPTION OF THE PREFERRED EMBODIMENT

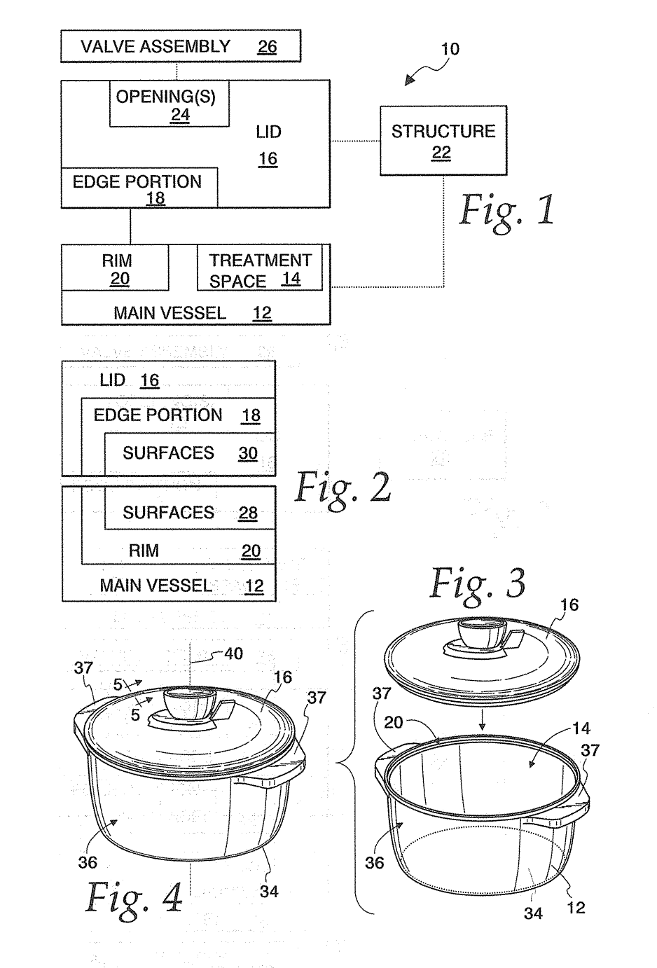

A cooking apparatus, according to the present invention, is shown schematically at 10 in FIG. 1. The cooking apparatus 10 has a main vessel 12 defining a treatment space 14 within which food products are placed.

The cooking apparatus 10 further includes a lid 16 that is repositionable relative to the main vessel 12 to selectively control access to the treatment space 14. The lid 16 has an edge portion 18 that cooperates with a rim 20 on the main vessel 12 with the lid 16 in a closed position.

The main vessel 12 and lid 16 are shown in schematic form to encompass virtually an unlimited number of different configurations therefor, with the exemplary main vessel 12 and lid 16 configuration, described hereinbelow, being representative in nature only.

For example, the main vessel 12 may have a constant radius around a central vertical axis. Alternatively, the shape may be oval, square, etc.

The edge portion 18 and rim 20 may extend in a continuous configuration. Alternatively, the lid 16 may extend only partially around the perimeter of the main vessel 12 at the rim 20.

In a further variation, the lid 16 may be maintained in its closed position only by reason of its weight. In an alternative form, separate structure 22 may cooperate between the main vessel 12 and lid 16 to securely maintain the lid 16 in its closed position. This structure 22 is not used in the preferred embodiment described hereinbelow, however it is contemplated that it might be incorporated.

The lid 16 may optionally have one or more openings 24 spaced inwardly from its perimeter edge portion 18 so that escape of vapor from the treatment space 14 through the opening(s) 24 to the surrounding atmosphere may occur. As shown in FIG. 1, a valve assembly 26 may be incorporated to control discharge of vapor through the opening(s) 24.

As shown in FIG. 2, the rim 20 on the main vessel 12 and edge portion 18 on the lid 16 have cooperating surfaces 28, 30, respectively, which cooperate to control vapor escape from the treatment space 14 with the lid 16 in its closed position. The cooperating surfaces 28, 30 may be multiple pairs of surfaces that face radially and/or axially and cooperate by being engaged and/or residing in close proximity to each other to control vapor escape.

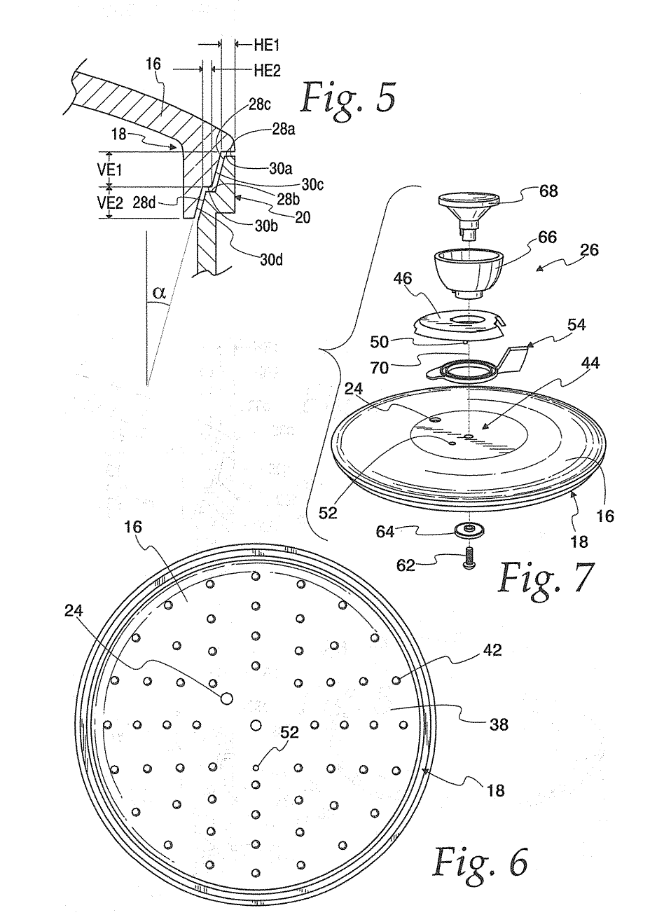

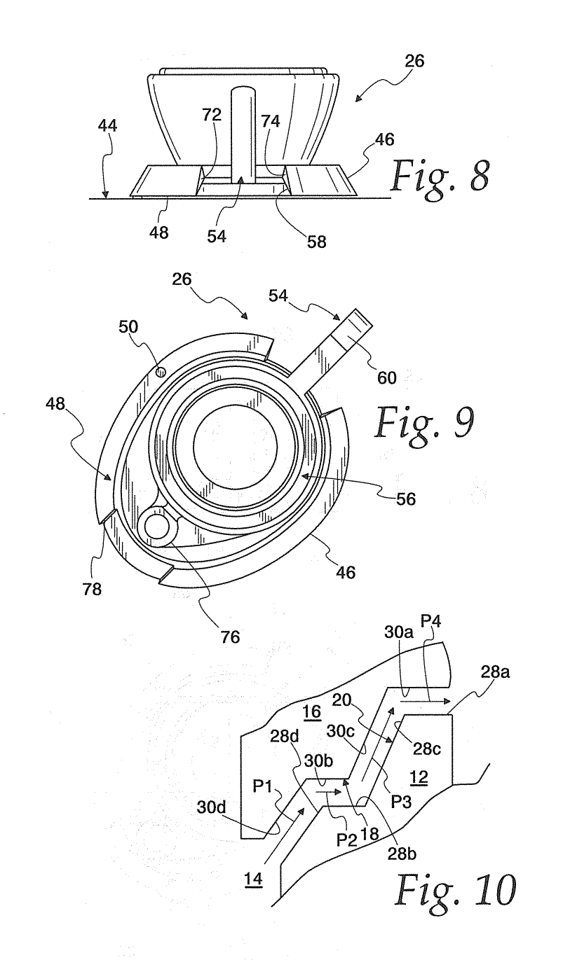

Referring now to FIGS. 3-10, one exemplary preferred form of the cooking apparatus 10 is shown in detail.

In this embodiment, the main vessel 12 has a generally flat bottom wall 34 and a peripheral wall 36 extending upwardly from the bottom wall 34 into the rim 20. Diametrically oppositely located handles 37 are integrally formed with peripheral wall 36 and can be grasped to controllably lift and reposition the main vessel 12. The bottom wall 34, peripheral wall 36, and inside surface 38 of the lid 16 cooperatively bound the treatment space 14 with the lid 16 in the closed position, as shown in FIG. 4.

In this embodiment, the cooking apparatus 10 has a central vertical axis 40 with the peripheral wall 36 having a constant radius from the axis 40. As noted above, this is not a requirement, with this particular shape being only exemplary.

The lid 16 is repositionable relative to the main vessel 12 to selectively control access to the treatment space 14. In this embodiment, the lid 16 is fully separable from the main vessel 12. However, it is contemplated that part of the lid 16 might be fixed relative to the main vessel 12 with only a part thereof being repositionable to selectively create an access opening and block the same. As depicted, each of the cooperating rim 20 and edge portion 18 extends in a continuous configuration fully around the axis 40.

One of the cooperating surface pair arrangements, shown schematically in FIG. 2, consists of first and second surfaces 28a, 28b on the rim 20 that each faces upwardly. The first surface 28a is above the surface 28b. While not a requirement, each of the surfaces 28a,28b has a generally flat shape.

The edge portion 18 on the lid 16 has separate surfaces 30a, 30b that are configured to cooperate, one each, with the surfaces 28a, 28b with the lid 16 in its closed position. The cooperating surfaces 28a, 30a; 28b, 30b may cooperate by engaging and/or residing in close proximity to each other along their peripheral extent. For example, there may be intimate contact over the full vertical extent or intimate contact over only a portion thereof. As a further alternative, other structure may maintain a slight spacing between the surfaces 28, 30 that cooperate between the rim 20 and edge portion 18.

As noted, the flat shape for the surfaces 28a, 28b, 30a, 30b is not a requirement. Any complementary shapes are contemplated, with the flat shape being preferred. The planes of one or both of the flat surface pairs 28a, 30a; 28b, 30b may be orthogonal to the axis 40 or angled with respect thereto.

The cooperating pair of surfaces 28a, 30a is spaced vertically above the cooperating surface pair 28b, 30b.

In the depicted embodiment, the rim 20 and edge portion 18 have separate, radially facing surface pairs 28c, 30c; 28d, 30d. The surface pairs 28c, 30c and 28d, 30d cooperate, as the other surface pairs, by either engaging and/or residing in close proximity with the lid 16 in its closed position. The cooperating surface pair 28c, 30c is spaced above the cooperating surface pair 28d, 30d.

Although not a requirement, the surfaces 28c, 28d, 30c, 30d each is substantially flat with the cooking apparatus 10 viewed in cross-section in a plane including the axis 40 with the lid 16 in its closed position. Each of the surfaces 28c, 28d, 30c, 30d is at an angle a with respect to the axis 40 thereby to guide, by a funneling action, the lid 16 downwardly into its closed position. The angle a is preferably less than 20°, however this is not a requirement. Alternatively, one, or both, of the cooperating surface pairs 28c, 30c; 28d, 30d might be made so that they extend parallel to the axis 40.

With the depicted arrangement, vapor generated in the treatment space is required to travel a circuitous route, as shown most clearly in schematic form in FIG. 10, through separate path portions P1-P4. Aside from creating a resistant path, the cooperating surfaces 28, 30 create redundant seals and also cause the vapor to flow against surfaces over a significant extent whereby it is caused to condense.

As shown in FIG. 10, with the spacing between the surfaces 28, 30 exaggerated, vapor in the treatment space 14 travels upwardly through the path portion P1 between the surfaces 28d, 30d. The vapor in path portion P1 is deflected horizontally and into the path portion P2 between the surfaces 28b, 30b, after which it deflects vertically into the path portion P3 between the surfaces 28c, 30c, and ultimately horizontally into the path portion P4 between the surfaces 28a, 30a.

While in a preferred form all of the cooperating surfaces 28, 30 are utilized, as noted above, adequate vapor control may be achieved by incorporating less than all of the cooperating surface pairs. For example, the surface pairs 28a, 30a and 28b, 30b might be utilized with the cooperating surface pair 28c, 30c therebetween, and without the surface pair 28d, 30d. In an alternative arrangement, the surface pairs 28c, 30c and 28d, 30d might be utilized with the surface pair 28b, 30b therebetween and without the cooperating surface pair 28a, 30a.

In the depicted embodiment, the cooperating surface pairs 28c, 30c and 28d, 30d respectively have vertical extents VE1, VE2 that are approximately the same. While the surfaces 28c, 30c both have the same vertical extent VE1, this is not a requirement, nor is it a requirement that the surfaces 28d, 30d have the same vertical extent VE2.

In the depicted embodiment, the vertical extent VE1 and vertical extent VE2 are on the order of 3/16 of an inch. However, this is a dimension that varies based upon the particular size and intended use for the cooking apparatus 10. These dimensions are only exemplary in nature.

The surfaces 28a, 30a and 28b, 30b respectively have horizontal extents HE1, HE2. As with the radially facing surfaces, the surfaces 28a, 30a do not have to have the same radial/horizontal extent, nor must the surfaces 28b, 30b have the same radial/horizontal extent. The dimensions HE1, HE2 are shown to be approximately the same, but this also is not a requirement. An exemplary dimension for HE1 and HE2 is on the order of ⅛″. Again this is dictated by the particular desired function and capacity for the cooking apparatus 10.

As seen in FIG. 6, the inside surface 38 of the lid 16 has an inverted cup shape. A plurality of discrete projections 42 are integrally formed with the lid material and facilitate accumulation of a fluid that is vaporized in the treatment space 14 and condensed at the inside lid surface 38. This condensed liquid then tends to drop downwardly off of the projections 42 to against the product being treated in the treatment space 14.

The main vessel 12 and lid 16 can be made from any suitable material. Typically, the cooperating surfaces 28, 30 are made from metal, with suitable metals known to those skilled in the industry. Coatings are commonly used by those in the industry and are contemplated for placement on the surfaces 28, 30.

The optional valve assembly 26 is shown incorporated into the lid 16 to selectively control discharge of vapor through an exemplary form with a single one of the aforementioned openings 24. The opening 24 is spaced radially inwardly from the edge portion 18 and allows escape of vapor from within the treatment space 14 with the lid 16 in its closed position.

There is no limitation as to the particular configuration of the valve assembly 26. Preferably, the valve assembly 26 is reconfigurable to allow controlled escape of different volumes of vapor from within the treatment space 14 with the lid 16 in its closed position.

In this embodiment, the top of the lid 16 has a flattened upper region at 44 at which the valve assembly 26 is placed. The valve assembly 26 consists of a base 46 with an underside 48 that is placed against the upper region 44. The base 46 has a locating lug 50 which fits into a complementarily-shaped opening 52 in the lid 16.

The base 46 has a cup shape for receiving a lever 54 with a flat underside 56 that rests against the flattened region 44. With the base 46 secured to the lid 16, the lever 54 is captively maintained in its operative position. The base 46 has a cutout 58 to accommodate an operating arm 60 on the lever 54 that projects outwardly from the base 46.

A threaded fastener 62 extends successively through a washer 64, the lid 16, the lever 54, the base 46, and a knob 66 with an inserted escutcheon 68. With the fastener 62 tightened, the lid 16, base 46, and knob 66 become rigidly mounted while allowing the lever 54 to pivot about an axis 70 defined by the fastener 62.

Turning of the knob 54 is limited by opposite edges 72, 74 of the cutout 58. At one extreme of travel, a tab 76 on the lever 54 overlies and blocks the opening 24. At the other extreme of travel, the opening 24 is fully exposed. In between, different degrees of registration of the tab 76 and opening 24 occur to change the discharge volume permitted through the opening 24.

A vent 78 is formed in the base 46 to allow the vapor discharging through the opening 24 to exit into the atmosphere. By having the tab 76 and vent 78 diametrically opposite to the operating arm 60, exposure of the user to discharging vapor is minimized as he/she grasps and repositions the operating arm 60.

The foregoing disclosure of specific embodiments is intended to be illustrative of the broad concepts comprehended by the invention.

1. A cooking apparatus comprising:
a main vessel defining a treatment space and having a bottom wall and a peripheral wall extending upwardly from the bottom wall into a rim; and
a lid that is repositionable relative to the main vessel to selectively control access to the treatment space,
the lid having an edge portion that cooperates with the rim with the lid in a closed position,
the rim having vertically spaced, upwardly facing, first and second surfaces,
the edge portion having third and fourth surfaces that are configured to cooperate, one each, with the first and second surfaces with the lid in the closed position to each engage and/or reside in close proximity to its respective cooperating first and second surface with the lid in the closed position.

2. The cooking apparatus according to claim 1 wherein each of the rim and edge portion extends in a continuous configuration.

3. The cooking apparatus according to claim 1 wherein the first surface and one of the third and fourth surfaces, that cooperates with the first surface with the lid in the closed position, each has a flat shape.

4. The cooking apparatus according to claim 3 wherein the second surface and the other of the third and fourth surfaces, that cooperates with the second surface with the lid in the closed position, each has a flat shape.

5. The cooking apparatus according to claim 1 wherein the main vessel has a vertical axis and the main vessel and lid have a first pair of radially facing surfaces that engage and/or reside in close proximity with the lid in the closed position.

6. The cooking apparatus according to claim 5 wherein the main vessel and lid have a second pair of radially facing surfaces that engage and/or reside in close proximity with the lid in the closed position.

7. The cooking apparatus according to claim 6 wherein the first and second pairs of radially facing surfaces are spaced vertically from each other with the lid in the closed position.

8. The cooking apparatus according to claim 6 wherein at least one of the first and second pairs of radially facing surfaces comprises surfaces that are substantially flat and angled with respect to the central axis as viewed in cross-section in a plane including the central axis so as to interact and guide the lid downwardly relative to the main vessel consistently into the closed position.

9. The cooking apparatus according to claim 8 wherein one of the first and second pairs of radially facing surfaces resides vertically between the first and second rim surfaces with the lid in the closed position.

10. The cooking apparatus according to claim 6 wherein the surfaces in the first pair of radially facing surfaces each has a first vertical extent with the lid in the closed position that is approximately the same and the surfaces in the second pair of radially facing surfaces each has a second vertical extent with the lid in the closed position that is approximately the same and the first and second vertical extents are approximately the same.

11. The cooking apparatus according to claim 1 wherein the main vessel has a vertical axis and the first and second surfaces have radial extents that are approximately the same.

12. The cooking apparatus according to claim 1 wherein each of the first and second surfaces is made from a metal material.

13. The cooking apparatus according to claim 1 wherein the lid has an inverted, cup-shaped inside surface bounding the treatment space with the lid in the closed position and there are a plurality of discrete projections at the inside surface that facilitate accumulation of a fluid that is vaporized in the treatment space and condensed at the inside lid surface.

14. The cooking apparatus according to claim 1 wherein the lid has a vertical axis and an opening spaced radially inwardly from the edge portion to allow escape of vapor from within the treatment space with the lid in the closed position.

15. The cooking apparatus according to claim 14 wherein the lid further comprises a valve assembly that is reconfigurable to allow controlled escape of different volumes of vapor from within the treatment space through the lid opening with the lid in the closed position.

16. The cooking apparatus according to claim 1 wherein the lid has a weight and the lid is maintained in the closed position by only the weight of the lid.

17. A cooking apparatus comprising:
a main vessel defining a treatment space and having a bottom wall and a peripheral wall extending upwardly from the bottom wall and extending into a rim; and
a lid that is repositionable relative to the main vessel to selectively control access to the treatment space,
the lid having an edge portion that cooperates with the rim with the lid in a closed position,
the main vessel having a vertical axis,
the main vessel and lid having first and second pairs of radially facing surfaces,
the surfaces in each of the first and second pairs of radially facing surfaces engaging and/or residing in close proximity with the lid in the closed position,
the first and second pairs of radially facing surfaces spaced vertically from each other with the lid in the closed position,
the main vessel and lid having cooperating axially oppositely facing surfaces, one each on the rim and edge portion, that engage and/or reside in close proximity with the lid in the closed position.

18. The cooking apparatus according to claim 17 wherein the axially oppositely facing surfaces reside between the first and second pairs of radially facing surfaces with the lid in the closed position.

19. The cooking apparatus according to claim 17 wherein at least one of the first and second pairs of radially facing surfaces comprises surfaces that are substantially flat and angled with respect to the central axis as viewed in cross-section in a plane including the central axis so as to interact and guide the lid downwardly relative to the main vessel into the closed position.

20. The cooking apparatus according to claim 17 wherein the lid has an opening spaced radially inwardly from the edge portion to allow escape of vapor from within the treatment space with the lid in the closed position.
